(19) United States
(12) Patent Application Publication
(10) Pub. No.: US 2010/0308588 A1
(43) Pub. Date: Dec. 9, 2010

(54) STABILIZATION OF TURBINES IN WATER

(76) Inventor: Daniel Farb, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/745,548

(22) PCT Filed: Oct. 2, 2008
(86) PCT No.: PCT/IB08/54018

§ 371 Date: May 31, 2010

Related U.S. Application Data
(60) Provisional application No. 60/991,789, filed on Dec. 3, 2007.
(60) Provisional application No. 61/058,235, filed on Jun. 3, 2008.

(51) Int. Cl. F03B 13/18; F03B 13/10

(52) U.S. Cl. 290/53; 290/54

(57) ABSTRACT

The present invention relates to devices and methods for using weights and cables for stabilizing turbines in water by attaching them to the ocean floor.

### FIELD AND BACKGROUND OF THE INVENTION

Stabilization of various kinds of turbines at or under the surface of a body of water is often difficult and expensive. The present invention presents simple configurations of weights and cables that have practical value in improving current practice. Current practice consists of using piles, which are heavy and expensive, or other types of cabling arrangements.

### BRIEF DESCRIPTION OF THE DRAWINGS

The invention is herein described, by way of example only, with reference to the accompanying drawings, wherein:

FIG. 1 is a diagram of vertical structures used to attach buoy or buoy-like turbines to the floor of a body of water.

FIG. 2 is a diagram of a variation of turbine attachment to the bottom of a body of water.

### DESCRIPTION OF THE PREFERRED EMBODIMENTS

The present invention relates to devices and methods of placing turbines in a body of water.

Definitions: “Body of water” can refer to any kind of fluid.

The principles and operation of an in-water turbine stabilization system according to the present invention may be better understood with reference to the drawings and the accompanying description. The inventions here described are not limited to use in conjunction with a turbine; that is simply the major application envisioned here.

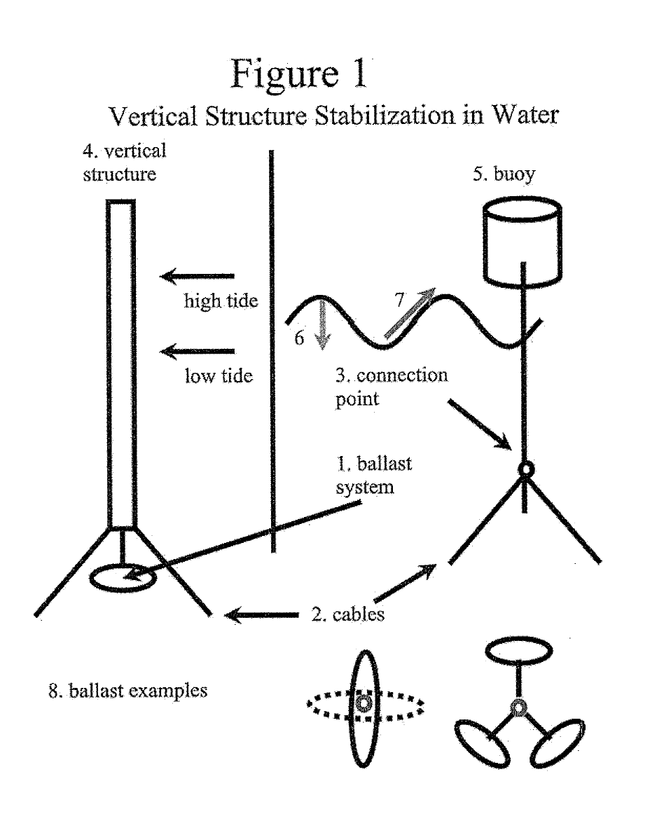

Referring now to the drawings, FIG. 1 illustrates on the left a vertical system or pole (4). In one embodiment, a turbine or other object may be attached to the top of it or any place along its length, and is particularly useful for underwater turbines. It is novel to connect such a system of cables to a pole instead of the turbine directly. In another and novel embodiment, a system with racks or grooves that enables vertical movement is part of the vertical pole. This is particularly useful for obtaining energy from waves. The vertical pole is attached to at least one cable (2) that is attached to at least one weight (not shown). In one embodiment, the vertical pole is attached to a ballast (1). In the ideal embodiment, the cable connection points to the pole are above the ballast.

One potential advantage of this system over piles is that, since it is not fixed, it can more easily absorb the force of an occasionally large wave and stabilize quickly. In smaller wave conditions, it will move very little

Several examples of ballast (8) are shown. The ballast may consist of more than one weight. If the extensions of the ballast are deeper and extended out from the bottom of the pole by rods, their weight has a greater effect to stabilize the top of the pole. The ballasts can be arranged so that they are separated and not present, in the area where the cable wires are so they don't hit the cables for any normal wave.

The right side of FIG. 1 shows how a buoy (5) can be attached to the ocean floor in order to obtain increased power. Since most buoys operate by vertical motion on the waves, allowing them to operate at a diagonal may improve power output, as shown by arrow (6) vertical versus arrow (7) diagonal, which enables the buoy to move farther with each wave. This requires an underwater connection point (3) between the cables that fix the connection point and the cable that goes from the connection point to the buoy (5). Thereby, it would traverse a longer path with each wave. The concept of making an underwater contact point from which a second cable system extends is a device and method for other applications.

For needs such as a wave energy converter, the vertical structure could extend above high tide level and below low tide level.

Furthermore, the methods and devices of making such a vertical structure that extends above the highest local wave height at high tide and below the lowest wave height (meaning the trough of a wave) at low tide are hereby claimed. The wave level may be defined as the highest historical or projected wave height in a certain location, or the height of 90%, 80%, 70%, 60%, or 50% or more of the waves in a certain location. The ballast for such a vertical structure is disclosed to be more than in the vertical line of the vertical structure and its orientation towards the source of fluid flow, but may also be located in at least two dimensions, in at least a horizontal plane, in order to provide stabilization for fluid motions in many directions.

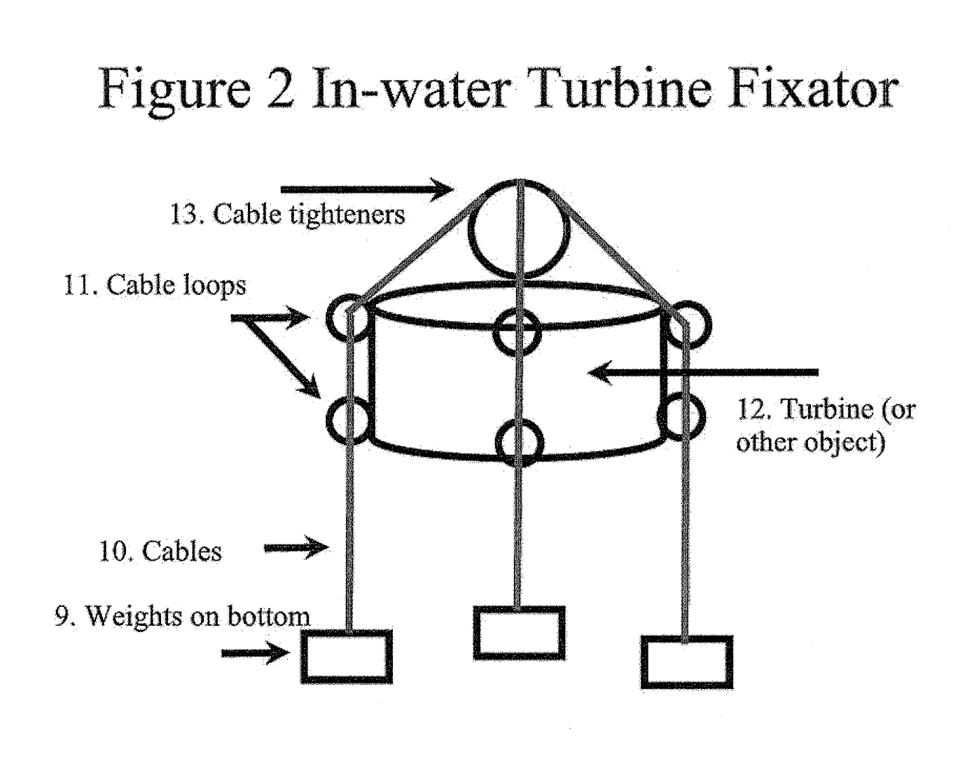

FIG. 2 shows a different embodiment of the concept. FIG. 2 could be used for any turbine, on or below the surface, but would work especially well for a vertical axis underwater current/tidal turbine. Weights (9) on the floor of a body of water attach via cables (10) to cable loops (11) on the sides, foils, supports, or walls of the turbine system (12). In one embodiment, each of them can enter a superior cable attachment device (13) that clusters the cables near a single point and tightens and fixes them. They can be loosened and adjusted as needed, for example, as the water level changes. In different embodiments, this can be done automatically or manually.

In another embodiment, a ballast could be attached at the bottom of the turbine system (12).

In all the cases described above, flotation is required to keep the turbine and its support positioned at the appropriate depth. An underwater turbine may be constructed with a flotation device underneath the hub or on the supporting structure beneath the hub, in different embodiments, so that it is easier to raise the hub to the surface for maintenance than if the flotation were located above or at the level of the hub. The flotation in one embodiment is variable, such as by using air.

A flotation device may also be attached to the vertical pole described in FIG. 1 or the tightening device in FIG. 2.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing solutions for placing turbines in water that are more cost-effective in certain circumstances and which have especially good integration with certain turbine innovations, such as providing flow-enhancing structures adjacent to the blades that also provide a structure for attaching cables.

It is now disclosed for the first time a system for stabilizing a pole in the water, comprising:

a. a vertical pole,
b. at least two weights on the floor of the body of water,
c. a cable attached to each weight on one side and the vertical pole on the other side, said attachments to the vertical pole being substantially adjacent vertically,
d. a ballast system extending from the vertical pole inferiorly.

According to another embodiment, a wave turbine is attached to the pole.

According to another embodiment, the wave turbine slides up and down the pole.

According to another embodiment, the area of sliding uses a rack/gear connection between the turbine and the pole.

According to another embodiment, the area of sliding uses a groove connection between the turbine and the pole.

In one embodiment, the system further comprises:

e. a flotation device inferior to the attachment of the turbine.

According to another embodiment, an underwater vertical axis turbine is attached to the pole.

According to another embodiment, an underwater horizontal axis turbine is attached to the pole.

According to another embodiment, the upper part of the pole is higher than the water surface at high tide, and the lower part of the pole is below the surface at low tide.

According to another embodiment, the vertical pole extends above the highest local wave height at high tide and below the lowest wave height (meaning the trough of a wave) at low tide

According to another embodiment, the parts of the ballast system are separated so that when the pole is vertical, the ballast pieces are not located in a line (meaning in a horizontal plane so that they don't hit each other if the vertical pole pivots) from the center of the pole to the cable.

It is now disclosed for the first time a ballast system, comprising:

a. cables attached to a central object,
b. ballast attached to said central object, wherein the ballast pieces are not located in a line from the center of the pole to the cable.

It is now disclosed for the first time a turbine support system in a fluid, comprising:

a. an ocean energy turbine,
b. a vertical pole attached to the turbine that is capable of sideways movement. (Such movement is defined for purposes of this patent as sideways movement with tipping to the side, not remaining completely vertical.)

It is now disclosed for the first time an object stabilization system, comprising:

a. an object at or near the surface,
b. at least two weights on the floor of the water,
c. cables from each weight to a connection point,
d. an upper cable connecting the connection point to the object.

According to another embodiment, the upper cable is extensible and whose vertical angle can vary by at least 5 degrees.

According to another embodiment, wherein the object is a turbine.

It is now disclosed for the first time an object stabilization system in a body of water, comprising:

a. an object,
b. at least two weights on the water floor,
c. cables attached to said weights,
d. cable attachment means on the object structure,
e. a cable tightener superior to the cable attachment means, to which said cables are attached.
(The cable tightener can function in many ways to enable movement to pull in or let out the cables, manually or automatically.)

According to another embodiment, the object is a vertical axis turbine.

According to another embodiment, the cable attachment means is on a foil structure of the turbine.

In one embodiment, the system further comprises:

f. a flotation device attached to the cable tightener.

According to another embodiment, the cable tightener operates under electronic control to tighten or loosen the cables.

What is claimed is:

1. A system for stabilizing a pole in the water, comprising:
a. a vertical pole,
b. at least two weights on the floor of the body of water,
c. a cable attached to each weight on one side and the vertical pole on the other side, said attachments to the vertical pole being substantially adjacent vertically,
d. a ballast system extending from the vertical pole inferiorly.

2. The system of claim 1, wherein a wave turbine is attached to the pole.

3. The system of claim 2, wherein the wave turbine slides up and down the pole.

4. The system of claim 3, wherein the area of sliding uses a rack/gear connection between the turbine and the pole.

5. The system of claim 3, wherein the area of sliding uses a groove connection between the turbine and the pole.

6. The system of claim 1, further comprising:
e. a flotation device inferior to the attachment of the turbine.

7. The system of claim 1, wherein an underwater vertical axis turbine is attached to the pole.

8. The system of claim 1, wherein an underwater horizontal axis turbine is attached to the pole.

9. The system of claim 1, wherein the upper part of the pole is higher than the water surface at high tide, and the lower part of the pole is below the surface at low tide.

10. The system of claim 1, wherein the vertical pole extends above the highest local wave height at high tide and below the lowest wave height (meaning the trough of a wave) at low tide

11. The system of claim 1, wherein the parts of the ballast system are separated so that when the pole is vertical, the ballast pieces are not located in a line from the center of the pole to the cable.

12. A ballast system, comprising:
a. cables attached to a central object,
b. ballast attached to said central object, wherein the ballast pieces are not located in a line from the center of the pole to the cable.

13. A turbine support system in a fluid, comprising:
a. an ocean energy turbine,
b. a vertical pole attached to the turbine that is capable of sideways movement.

14. An object stabilization system, comprising:
a. an object at or near the surface,
b. at least two weights on the floor of the water,
c. cables from each weight to a connection point,
d. an upper cable connecting the connection point to the object.

15. The system of claim 14, wherein the upper cable is extensible and whose vertical angle can vary by at least 5 degrees.

16. The system of claim 14, wherein the object is a turbine.

17. An object stabilization system in a body of water, comprising:
a. an object,
b. at least two weights on the water floor,
c. cables attached to said weights,
d. cable attachment means on the object structure,
e. a cable tightener superior to the cable attachment means, to which said cables are attached.

18. The system of claim 17, wherein the object is a vertical axis turbine.

19. The system of claim 17, wherein the cable attachment means is on a foil structure of the turbine.

20. The system of claim 17, further comprising:
f. a flotation device attached to the cable tightener.

21. The system of claim 17, wherein the cable tightener operates under electronic control to tighten or loosen the cables.
